(19) United States
(12) Patent Application Publication
(10) Pub. No.: US 2009/0160717 A1
(43) Pub. Date: Jun. 25, 2009

(54) Antenna device and wireless device

(75) Inventors: Yukako Tsutsumi, Yokohama-Shi (JP); Masaki Nishio, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/230,707

(22) Filed: Sep. 3, 2008

(30) Foreign Application Priority Data
Dec. 19, 2007 (JP) 2007-326968

(51) Int. Cl. H01Q 21/00

(52) U.S. Cl. 343/726

(57) ABSTRACT

There is provided with an antenna device including: a dipole element that includes a first linear element and a second linear element with each one end thereof being provided closely; a loop-shaped element that includes a third linear element and a fourth linear element provided approximately in parallel to the first linear element and the second linear element with each one end thereof being provided closely, and a fifth linear element with one end thereof being connected to the other end of the third linear element and the other end thereof being connected to the other end of the fourth linear element; and a feeding point feeding power to each one ends of the first linear element and the second linear element and to each one ends of the third linear element and the fourth linear element.

### CROSS REFERENCE TO RELATED APPLICATIONS

This application is based upon and claims the benefit of priority from the prior Japanese Patent Applications No. 2007-326968, filed on Dec. 19, 2007; the entire contents of which are incorporated herein by reference.

### BACKGROUND OF THE INVENTION

1. Field of the Invention

The present invention relates to an antenna device and a wireless device.

2. Related Art

When a lossy material such as a human body comes close to an antenna, the antenna characteristics will deteriorate. To solve this problem, Patent Document JP-A 2006-217129 (Kokai) proposes a technique of branching a conductor wire of at least one of the feeding portion and the short-circuit portion of the antenna into a plurality of lines; running the lines in parallel at a predetermined spacing; and then joining together the lines again at another point. Since at least one of the feeding portion and the short-circuit portion of the antenna which will be most affected when a lossy material and the like come close to the lines is divided into a plurality of lines, this technique can suppress the antenna characteristics from deteriorating even if any one of the plurality of lines is affected by the lossy material or the like.

Unfortunately, according to the conventional antenna device described above, when any one of the plurality of lines is affected by a lossy material or the like, a flowing electric current is changed in the remaining lines connected to the affected line and the antenna input impedance is fluctuated. In the first place, it is a rare case that any one of the plurality of lines is affected by a lossy material or the like, and in fact, the overall effect is considered to deteriorate the radiation efficiency.

### SUMMARY OF THE INVENTION

According to an aspect of the present invention, there is provided with an antenna device comprising:

a dipole element that includes a first linear element and a second linear element with each one end thereof being provided closely, the dipole element having a length of approximately one-half of a wavelength of an operating frequency;

a loop-shaped element that includes a third linear element and a fourth linear element provided approximately in parallel to the first linear element and the second linear element with each one end thereof being provided closely, and a fifth linear element with one end thereof being connected to the other end of the third linear element and the other end thereof being connected to the other end of the fourth linear element, the loop-shaped element having a length of approximately one wavelength of an operating frequency; and

a feeding point feeding power to each one ends of the first linear element and the second linear element and to each one ends of the third linear element and the fourth linear element.

According to an aspect of the present invention, there is provided with a wireless device comprising:

an antenna device as claimed in claim 1; and

a wireless chip configured to perform wireless communication through the antenna device.

### BRIEF DESCRIPTION OF THE DRAWINGS

FIG. 1 shows a schematic configuration of an antenna device in accordance with a first embodiment of the present invention;

FIG. 2 is a view of the antenna device of FIG. 1 broken down into two antennas;

FIG. 3 shows a current intensity distribution in a predetermined frequency of the antenna device of FIG. 1;

FIG. 4 shows a direction of a flowing current in a predetermined frequency of the antenna device of FIG. 1;

FIG. 5 is a drawing explaining a direction of radiating an electromagnetic wave;

FIG. 6 is a graph showing a relation between a distance between A-A′ portion and B-B′ portion and a current ratio of B-B′ portion and C-C′ portion shown in FIGS. 3 and 4;

FIG. 7 shows a direction of a flowing current in a predetermined frequency of the antenna device of FIG. 2;

FIG. 8 shows a schematic configuration of an antenna device in accordance with a second embodiment of the present invention;

FIG. 9 shows an electromagnetic field simulation result of a radiating pattern (antenna absolute gain pattern) of the antenna device of FIG. 8;

FIG. 10 shows an electromagnetic field simulation result of a reflection coefficient when an infinite ground plate is provided on a surface in parallel to the antenna device of FIG. 8;

FIG. 11 shows a schematic configuration of an antenna device in accordance with a third embodiment of the present invention;

FIG. 12 shows a schematic configuration of an antenna device in accordance with a fourth embodiment of the present invention;

FIG. 13 shows a schematic configuration of an antenna device in accordance with a fifth embodiment of the present invention;

FIG. 14 shows a schematic configuration of a wireless device in accordance with a sixth embodiment of the present invention;

FIG. 15 shows a schematic configuration of a wireless device in accordance with a seventh embodiment of the present invention;

FIG. 16 shows a schematic configuration of a wireless device in accordance with an eighth embodiment of the present invention;

FIG. 17 shows a schematic configuration of a wireless communication device in accordance with a ninth embodiment of the present invention;

FIG. 18 shows a schematic configuration of a wireless device in accordance with a tenth embodiment of the present invention;

FIG. 19 shows a schematic configuration of a wireless device in accordance with a eleventh embodiment of the present invention; and

FIG. 20 shows a schematic configuration of a wireless communication device in accordance with a twelfth embodiment of the present invention.

### DETAILED DESCRIPTION OF THE INVENTION

Hereinafter, present embodiments will be described in detail with reference to drawings.

### First Embodiment

FIG. 1 shows a schematic configuration of an antenna device in accordance with a first embodiment of the present invention.

This antenna device is provided with a first metal portion 2 and a second metal portion 3 forming a dipole element; a third metal portion 4 forming a loop-shaped element; and a feeding point 1 feeding power to the dipole element and the loop-shaped element. The first metal portion 2, the second metal portion 3 and the third metal portion 4 are configured with a wire or a strip line, which is formed, for example, by copper, aluminum, gold, or the like.

The first metal portion 2 and the second metal portion 3 are approximately linearly arranged with a respective one end thereof close to each other. The first metal portion 2 and the second metal portion 3 correspond to, for example, a first linear element and a second linear element. Each of the first metal portion 2 and the second metal portion 3 has an electrical length of approximately one-fourth of a wavelength of an operating frequency. In other words, the dipole element consisting of the first metal portion 2 and the second metal portion 3 has an electrical length of approximately one-half of a wavelength of the operating frequency.

The third metal portion (loop-shaped element) 4 has an electrical length of approximately one wavelength of a of the operating frequency with a conductor element arranged around in a loop shape starting at one end thereof. More specifically, the third metal portion 4 includes a third linear element 41a and a fourth linear element 41b with a respective one end thereof close to each other; and a fifth linear element 41c with one end thereof connected to the other end of the third linear element 41a and the other end thereof connected to the other end of the fourth linear element 41b; and the third linear element 41a and the fourth linear element 41b are approximately in parallel to the first metal portion (first linear element) 2 and the second metal portion (second linear element) 3. The third linear element 41a and the fourth linear element 41b are close to the first metal portion 2 and the second metal portion 3 respectively with the spacing being approximately one-tenth or less of a wavelength.

The both ends (i.e., one end portion of the third linear element and the fourth linear element) of the third metal portion (loop-shaped element) 4 are folded outward of the loop, and each one end of the first metal portion 2 and the second metal portion 3 is connected to each folded end thereof.

The feeding point 1 feeds power to the one and the other end of the third metal portion (loop-shaped element) 4; and feeds power to each one of the first metal portion (first loop-shaped element) 2 and the second metal portion (second loop-shaped element) 3. In other words, the feeding point 1 serves as a feeding point common to the loop-shaped element and the dipole element.

Hereinafter, the operation of the antenna device of FIG. 1 will be described.

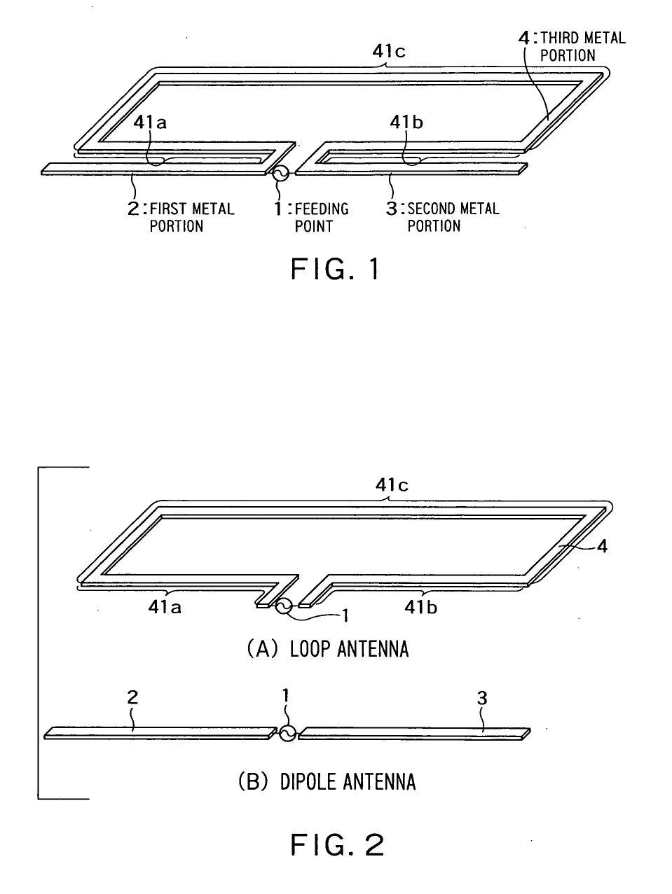

The antenna device of FIG. 1 can be broken down into a loop antenna having an approximate one wavelength of the operating frequency shown in FIG. 2A; and a dipole antenna having an approximate one-half wavelength of the operating frequency shown in FIG. 2B. The loop antenna of FIG. 2A includes the third metal portion 4 and the feeding point 1. The dipole antenna of FIG. 2B includes the first metal portion 2, the second metal portion 3 and the feeding point 1.

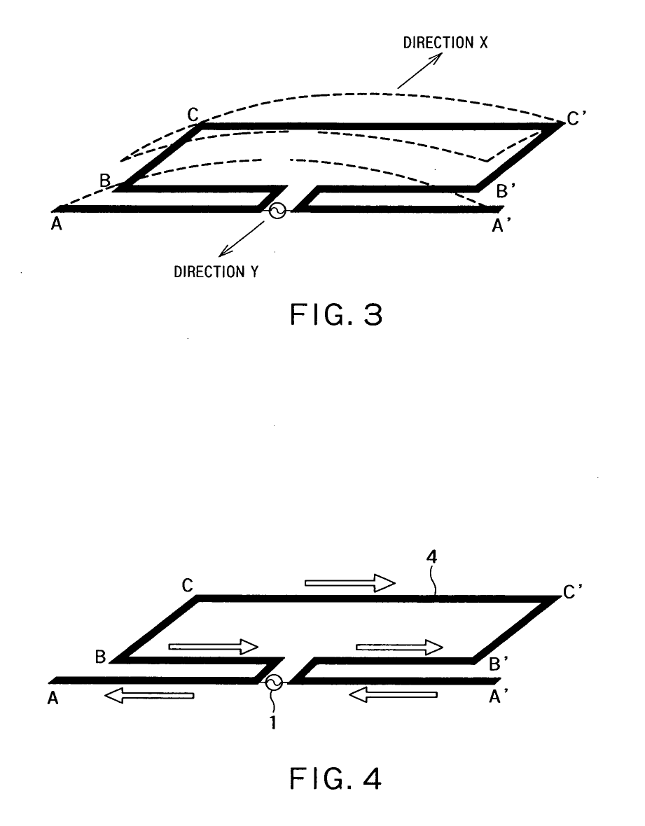

FIG. 3 shows a current intensity distribution with a dotted line in the operating frequency of the antenna device of FIG. 1. FIG. 4 shows a direction of a flowing current in the operating frequency of the antenna device of FIG. 1.

FIG. 3 indicates that the longer the distance from the antenna element to the dotted line, the stronger the current intensity. The distribution indicates that each middle point of the A-A′ portion, the B-B′ portion and the C-C′ portion is in an “antinode” of the current intensity.

With reference to FIG. 4, for the current phase, the length of the third metal portion 4 is approximately one wavelength. Therefore, approximately 180 degrees of phase difference occurs between the B-B′ portion and the C-C′ portion. When the current path is considered, the B-B′ portion and the C-C′ portion show a current distribution near in-phase as shown in the figure. In addition, the path length of the A-B portion or the A′-B′ portion is an approximately one-half wavelength and an approximately middle point of the A-B portion or the A′-B′ portion is in an “antinode” of the current. Therefore, when the current path is considered, the A-A′ portion and the B-B′ portion show a current distribution near anti-phase as shown in the figure.

As described above, since the A-A′ portion and the B-B′ portion are approximately in parallel and close to each other, strong binding occurs therebetween, strengthening the current intensity with each other. As a result, the current intensity distribution of the B-B′ portion is larger than that of the C-C′ portion; and the intensity distributions of the current of the A-A′ portion and the current of the loop-shaped element (synthetic current of the B-B′ portion and the remaining portion including C-C′ portion) are approximately the same. In other words, the flowing current of the dipole-shaped element is larger than that of the loop-shaped element, for the reasons that from the point of view of the feeding point 1, the dipole-shaped element seems to be lower in impedance than the loop-shaped element, and the like. A large current of the dipole-shaped element strengthens the current intensity of the B-B′ portion; on the contrary, the current (lower than that of the dipole-shaped element) of the loop-shaped element strengthens the current intensity of the dipole-shaped element. As a result, the intensity distributions of the current of the A-A′ portion and the current of the loop-shaped element (synthetic current of the B-B′ portion and the remaining portion including C-C′ portion) are approximately the same.

In the Y direction (see FIG. 3) seen from the B-B′ portion to the A-A′ portion, the phase difference between an electromagnetic wave radiated from the current of the loop-shaped element (synthetic current of the B-B′ portion and the remaining portion including C-C′ portion) and an electromagnetic wave radiated from the A-A′ portion is 180 degrees, i.e., nears anti-phase. Consequently, the electromagnetic waves are cancelled with each other, and the radiation is greatly suppressed in the Y direction. On the other hand, in the X direction (see FIG. 3) seen from the A-A′ portion to the B-B′ portion, the phase difference between an electromagnetic wave radiated from the current of the loop-shaped element (synthetic current of the B-B′ portion and the remaining portion including C-C′ portion) and an electromagnetic wave radiated from the A-A′ portion is out of 180 degrees. Consequently, the electromagnetic waves are not cancelled with each other, and the radiation is not suppressed in the X direction. Accordingly, the present antenna device can greatly suppress the radiation in the Y direction, and is little affected by a metal or lossy material placed in the Y direction, thereby suppressing the radiation efficiency from deteriorating.

Here, the reason that the radiation in the Y direction can be greatly suppressed by electromagnetic wave cancellation, and the radiation in the X direction cannot be suppressed will be described in detail.

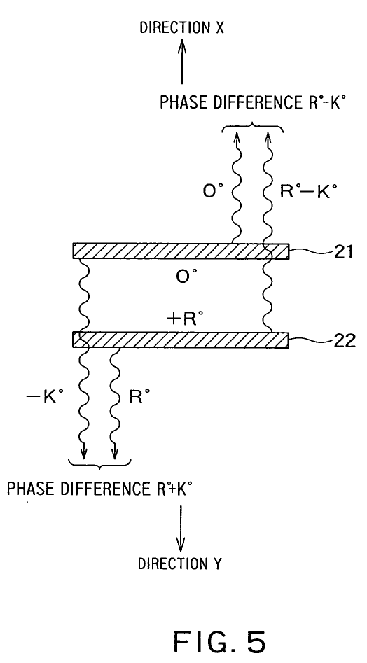

FIG. 5 is a schematic drawing of a radiating element of the antenna device of FIG. 1. In FIG. 5, the reference numeral 21 denotes the third metal portion (loop-shaped element) 4, and the reference numeral 22 denotes the dipole-shaped element (first metal portion 2 and second metal portion 3).

The current of the dipole-shaped element 22 (first metal portion 2 and second metal portion 3) advances in phase by about R° than the current of the third metal portion (loop-shaped element) 21. Assuming that the phase of an electromagnetic wave radiated from the third metal portion (loop-shaped element) 21 at a certain time is 0°, the phase of an electromagnetic wave radiated from the dipole-shaped element 22 is R°. Seeing from the loop-shaped element 21 toward the dipole-shaped element 22 on the basis of the position of the dipole-shaped element 22, the phase corresponding to the distance between the loop-shaped element 21 and the dipole-shaped element 22 (approximately one-tenth wavelength or less as described above) is K°. Therefore, the phase of the electromagnetic wave which is radiated from the loop-shaped element 21 and reaches the dipole-shaped element 22 is 0°−K°=−K°. Consequently, in the direction seen from the loop-shaped element 21 to the dipole-shaped element 22, the phase difference between the phase (−K°) of the electromagnetic wave radiated from the loop-shaped element 21 and the phase (R°) of the electromagnetic wave radiated from the dipole-shaped element 22 is R°−(−K°)=(R+K)°. This phase is about near anti-phase. Accordingly, in the direction from the loop-shaped element 21 to the dipole-shaped element 22, the electromagnetic waves are cancelled and practically no radiation occurs.

On the contrary, when seen from the dipole-shaped element 22 to the loop-shaped element 21, the phase difference between the phase (R°+(−K°) of the electromagnetic wave which is radiated from the dipole-shaped element 22 and reaches the loop-shaped element 21 and the phase (0°) of the electromagnetic wave radiated from the loop-shaped element 21 is (R−K)°−0°=(R−K)° by considering in the same way. Since the value is greatly out of phase from the 180 degrees, the radiation in the direction seen from the dipole-shaped element 22 to the loop-shaped element 21 is not suppressed.

Here, in order to enhance the effect of electromagnetic wave cancellation, the current of the loop-shaped element (synthetic current of the B-B′ portion and the remaining portion including the C-C′ portion) is required to be approximately equal to the current of the A-A′ portion. For this purpose, according to the present embodiment, as described above, the A-A′ portion is placed close to the B-B′ portion to generate strong binding, thereby strengthening the current of the B-B′ portion. With that in mind, the present inventors performed an electromagnetic field simulation to find how far the distance should be between the B-B′ portion and the A-A′ portion required to generate strong binding between the B-B′ portion and the A-A′ portion. The results will be described as follows.

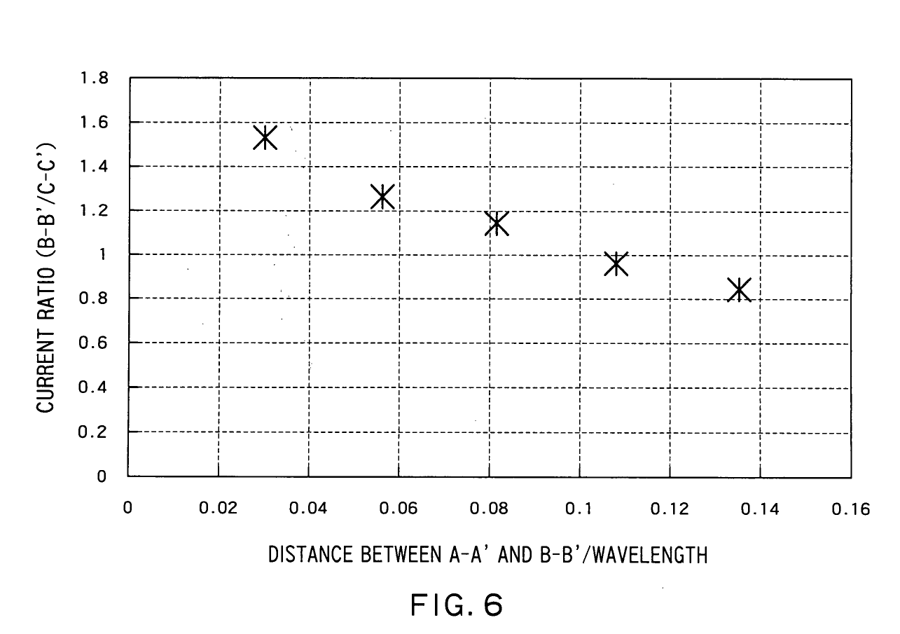

FIG. 6 is a graph showing a relation between a distance between the A-A′ portion and the B-B′ portion and a current ratio between the B-B′ portion and the C-C′ portion, which were obtained by the electromagnetic field simulation. It can be confirmed that when the distance between the A-A′ portion and the B-B′ portion is approximately one-tenth or less of a wavelength, the current intensity of the B-B′ portion is larger than that of the C-C′ portion, which means that strong binding is generated between the A-A′ portion and the B-B′ portion. Consequently, it is preferable that the distance between the A-A′ portion and the B-B′ portion should be close to each other with the distance therebetween being approximately one-tenth or less.

As described above, the present antenna device is little affected by a metal or lossy material provided in the Y direction and can suppress the radiation efficiency from deteriorating. Further, the present antenna device also has an advantage of reducing the variation of input impedance at the feeding point 1 even if the metal or lossy material comes close to the antenna device. Further detailed description is given below.

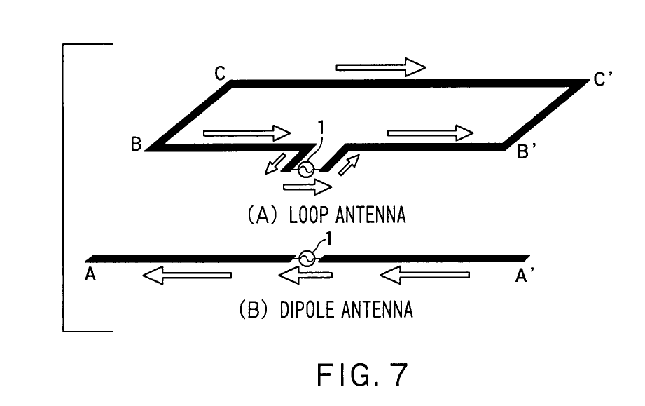

As described above, the antenna device of FIG. 1 can be broken down into the loop antenna of FIG. 2A and the dipole antenna of FIG. 2B. FIGS. 7A and 7B show the respective antennas with the directions of the current flow therein illustrated.

The phase of the current at feeding point 1 of the loop antenna of FIG. 7A is reversed to the phase of the current at feeding point 1 of the dipole antenna of FIG. 7B, and the phases are cancelled with each other. Consequently, even if a metal or lossy material comes close to the antenna device, the changes in current at feeding point 1 due to the approach of such material are cancelled. Therefore, the variation of input impedance at feeding point 1 can be reduced even if the metal or lossy material comes close to the antenna device.

### Second Embodiment

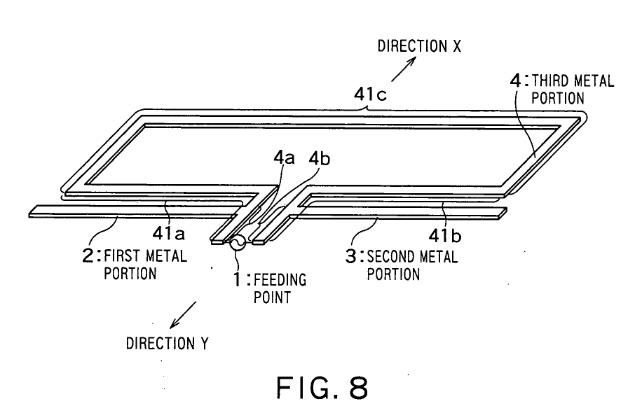

FIG. 8 shows a schematic configuration of an antenna device in accordance with a second embodiment of the present invention.

According to the first embodiment, each one end of the first metal portion 2 and the second metal portion 3 is connected directly to the feeding point 1; while according to the second embodiment, each one end thereof is connected to a middle of the folded portion of the third metal portion 4. Consequently, according to the first embodiment, the dipole element is composed of the first metal portion 2 and the second metal portion 3; while according to the second embodiment, the dipole element is composed of the portions 4a and 4b each extending from the connection point with the first and the second metal portion 2, 3 to one end and the other end of the third metal portion 4; and the first metal portion 2 and the second metal portion 3. The power feeding is performed to the dipole element by the power feeding from one end and the other end of the third metal portion 4. The dipole element has an electrical length of approximately one-half of a wavelength of the operating frequency in the same way as in the first embodiment.

In this configuration, the distance between the first metal portion 2 and the second metal portion 3 and the feeding point 1 increases and the distance between the loop portion serving as the main radiation portion of the third metal portion 3 and the feeding point 1 increases. Consequently, the present antenna is difficult to be affected by a circuit element or the like (not shown) to be connected to the feeding point 1 and can further suppress the radiation efficiency from deteriorating.

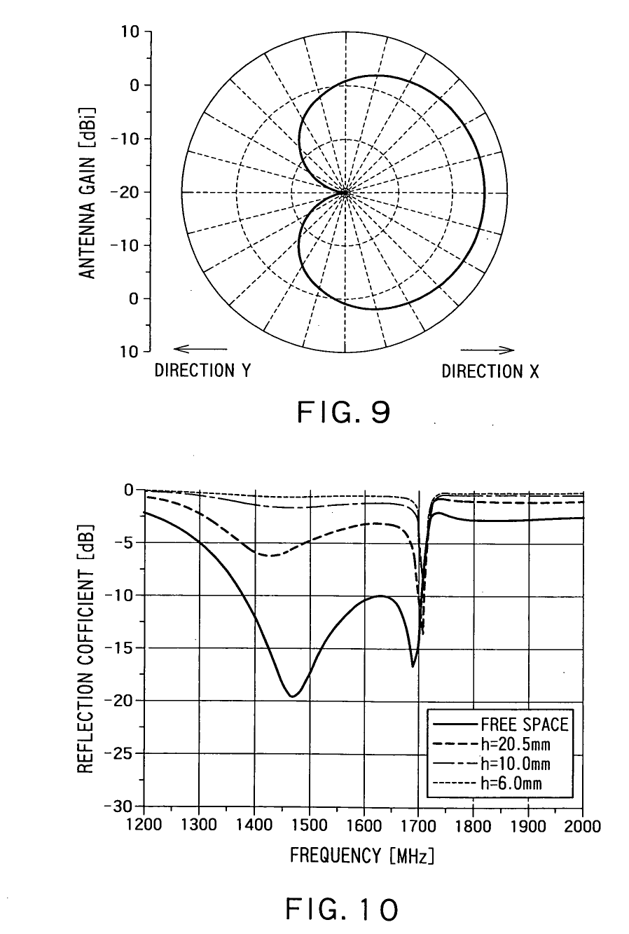

FIG. 9 shows an electromagnetic field simulation result of a radiating pattern (antenna absolute gain pattern) of the antenna device of FIG. 8 when each length of the first metal portion 2 and the second metal portion 3 is set to 43 mm; and the distance between the first metal portion 2 and the second metal portion 3 and the third metal portion 3 in parallel to these portions is set to 3 mm.

The direction X and the direction Y in FIG. 9 are the same as the direction X and the direction Y in FIG. 8. It can be confirmed that radiation is suppressed by an electromagnetic wave cancellation in the Y direction. An approximately 25 dB of FB (Front to Back) ratio is obtained between the direction X and the direction Y.

FIG. 10 shows an electromagnetic field simulation result of a reflection coefficient (ratio between an input voltage and a reflected voltage) when an infinite ground plate (conductor ground plane) is provided on a surface in parallel to the antenna device of FIG. 8 under the same conditions as in FIG. 9; and also shows an electromagnetic field simulation result of a reflection coefficient when the antenna device is provided in a free space.

The simulation was performed by changing “h” in three ways: 20.5 mm, 10.0 mm, 6.0 mm, assuming the distance between a plane where the antenna device exists and the infinite ground plate is “h”. As a result, the reflection coefficient remains reduced in about 1,700 MHz of operating frequency when the infinite ground plate comes close to the antenna device of FIG. 8 such as 20.5 mm (approximately one-ninth wavelength), 10 mm (approximately one-eighteenth wavelength), and 6 mm (approximately one-thirtieth wavelength), which confirms that input impedance is small.

### Third Embodiment

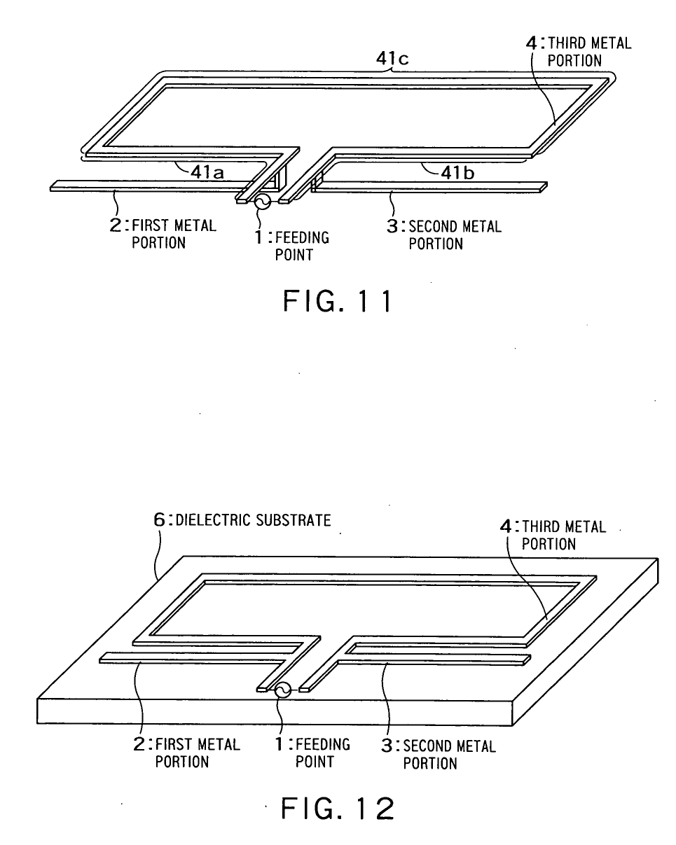

FIG. 11 shows a schematic configuration of an antenna device in accordance with a third embodiment of the present invention.

The antenna device is characterized in that the first metal portion 2 and the second metal portion 3 are formed on a plane different from a plane where the third metal portion 4 and the feeding point 1 exist.

As described above, the direction of suppressing radiation is inclined from the horizontal direction by forming the first metal portion 2 and the second metal portion 3 on a plane different from a plane where the third metal portion 4, and it is possible to further strengthen the effect of suppressing radiation efficiency when a metal or lossy material is placed in the inclined direction.

Here, the example shows that the first metal portion 2 and the second metal portion 3 of the antenna device of FIG. 8 are formed on a plane different from a plane where the third metal portion 4 exists, but the first metal portion 2 and the second metal portion 3 of the antenna device of FIG. 1 may be formed on a plane different from a plane where the third metal portion 4 exists.

### Fourth Embodiment

FIG. 12 shows a schematic configuration of an antenna device in accordance with a fourth embodiment of the present invention.

This antenna device is provided with a dielectric substrate 6 and the antenna device of FIG. 8 formed on the dielectric substrate 6. Examples of the dielectric substrate 6 include an epoxy substrate, a glass substrate, a ceramic substrate, and a Teflon substrate. Instead of a dielectric substrate, a semiconductor substrate such as silicon, silicon germanium, gallium arsenide and the like may be used.

Consequently, design flexibility can be increased and the antenna can be easily provided far away from a metal or lossy material by forming the antenna device of FIG. 8 on the dielectric substrate 6.

Here, the example shows that the antenna device of FIG. 8 is provided on the dielectric substrate 6, but the antenna device may be embedded in the dielectric substrate 6. Alternatively, the antenna device of FIG. 1 or 11 may be provided on or in the dielectric substrate 6. Further, the antenna device of FIG. 11 may be provided such that the dielectric substrate 6 is sandwiched between the first metal portion 2 and the second metal portion 3, and the third metal portion 4.

### Fifth Embodiment

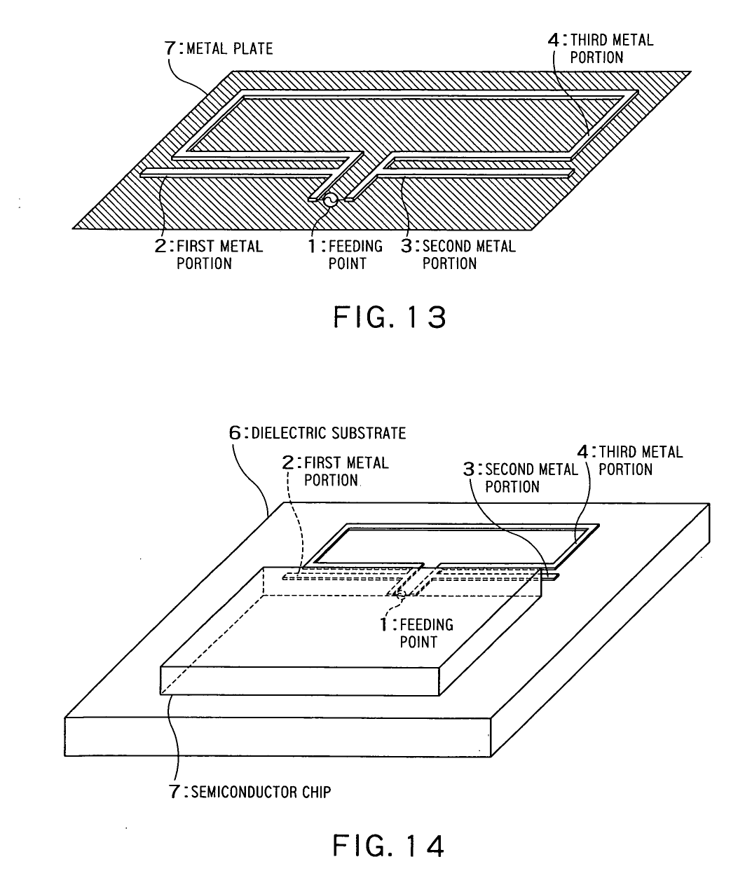

FIG. 13 shows a schematic configuration of an antenna device in accordance with a fifth embodiment of the present invention.

This antenna device is configured such that the antenna device of FIG. 8 is provided in a certain height above from a metal plate 7 approximately in parallel to the metal plate 7. The antenna device provided above the metal plate 7 in this manner can suppress the effect of a lossy material or circuit element on the back of the metal plate 7 since the variation of input impedance remains reduced by the advantageous effect of the present invention. It should be noted that the electromagnetic field simulation result of a reflection coefficient when the metal plate is provided in parallel to the plane where the antenna device of FIG. 8 exists is the same as already shown in FIG. 10.

Here, the example shows that the antenna device of FIG. 8 is provided above the metal plate 7, but it is apparent that the same advantageous effect can be obtained by providing the antenna device of FIG. 1 or 11 above the metal plate 7.

### Sixth Embodiment

FIG. 14 shows a schematic configuration of a wireless device in accordance with a sixth embodiment of the present invention.

The wireless device is provided with a dielectric substrate 6; a semiconductor chip (wireless chip) 7 provided on the dielectric substrate 6; and the antenna device of FIG. 8 provided on the dielectric substrate 6; wherein the semiconductor chip 7 is connected to the feeding point 1. The semiconductor chip is made of, for example, silicon, silicon germanium, gallium arsenide, or the like.

Even if the antenna device is connected to the semiconductor chip 7, it is possible to suppress the deterioration of the radiation efficiency and the variation of input impedance by the lossy semiconductor chip 7.

Here, the example shows that the antenna device of FIG. 8 is provided on the dielectric substrate 6, but the antenna device may be embedded inside the dielectric substrate 6. In addition, the example shows that the antenna device of FIG. 8 is used, but the antenna device of FIG. 1 or 11 may be used.

### Seventh Embodiment

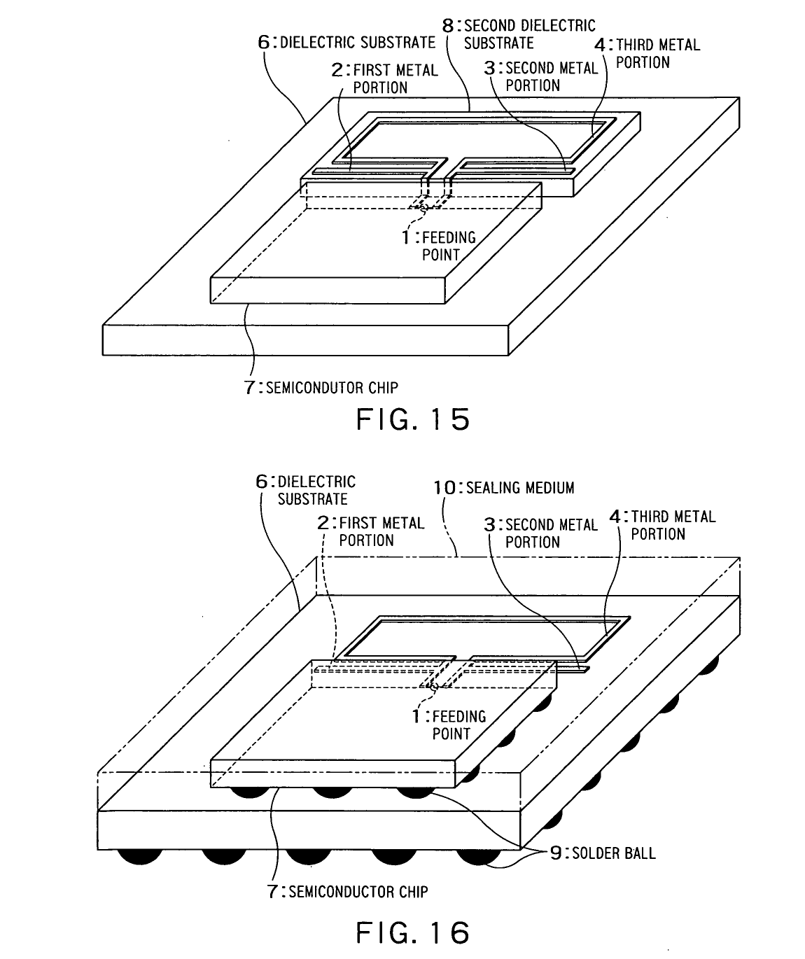

FIG. 15 shows a schematic configuration of a wireless device in accordance with a seventh embodiment of the present invention.

This wireless device is a modification of the wireless device of FIG. 14, and the antenna device is provided on the second dielectric substrate 8 installed on the dielectric substrate 6.

The antenna device can be provided as high as the semiconductor chip 7 or higher than the semiconductor chip 7 by providing the antenna device on the second dielectric substrate 8 in this manner. Therefore, it is possible to enhance the flexibility of where the antenna device is placed.

Here, the example shows that the antenna device of FIG. 8 is provided on the second dielectric substrate 8, but the antenna device may be embedded inside the second dielectric substrate 8. In addition, here, the example shows that the antenna device of FIG. 8 is used, but the antenna device of FIG. 1 or 11 may be used.

### Eighth Embodiment

FIG. 16 shows a schematic configuration of a wireless device in accordance with an eighth embodiment of the present invention.

The wireless device is configured such that the antenna device of FIG. 8 is installed in a semiconductor package.

A solder ball 9 is provided on the bottom face of the semiconductor chip 7 and is sandwiched between the semiconductor chip 7 and the dielectric substrate 6. The solder ball 9 may be replaced with wire bonding. Further, the solder ball 9 for installation on a circuit board or the like is provided on the bottom face of the dielectric substrate 6. The antenna device is connected to the semiconductor chip 7 through the feeding point 1. The antenna device and the semiconductor chip 7 are sealed by the sealing medium 10. Alternatively, a dielectric such as a glass substrate and a silicon substrate may be separately provided in the sealing medium 10 above the antenna device of FIG. 8 to obtain a desired characteristic.

In this way, a built-in antenna semiconductor package module which is difficult to be affected by a lossy material, metal or the like inside the package can be implemented. Since an antenna device has already been built in the package, the antenna device is not required to be disposed on any other location when the package is positioned, thereby contributing to saving space.

Here, the example shows that the antenna device of FIG. 8 is provided on the dielectric substrate 8, but the antenna device may be embedded inside the dielectric substrate 6. In addition, here, the example shows that the antenna device of FIG. 8 is used, but the antenna device of FIG. 1 or 11 may be used.

### Ninth Embodiment

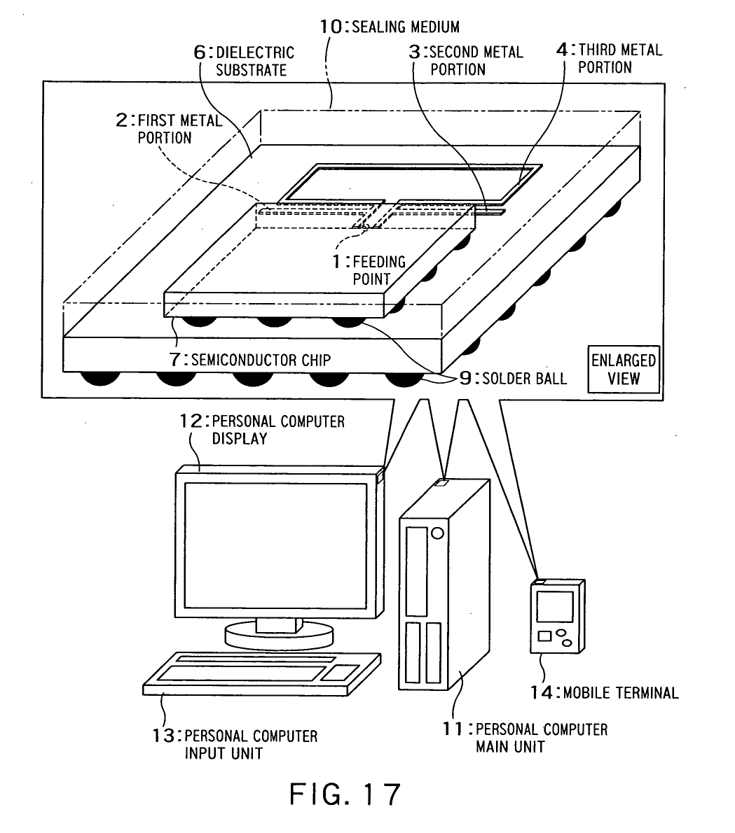

FIG. 17 shows a schematic configuration of a wireless communication device in accordance with a ninth embodiment of the present invention.

The wireless communication device is configured such that the wireless device of FIG. 16 is installed on a device for sending and receiving data or images. The wireless communication device is provided with a main unit 11 for processing data and the like; a display 12 for displaying the processed results and the like by the main unit 11; and an input unit 13 for a user to enter information.

The wireless device of FIG. 16 is provided inside or outside of the main unit 11 and display 12, which perform the mutual communication using a millimeter-wave band frequency. For example, the main unit 11 sends processed data to the display 12 through the wireless device of FIG. 16; and the display 12 receives data from the main unit 11 through the wireless device of FIG. 16 and displays the received data for the user.

Here, the description is made by the example showing that the wireless device of FIG. 16 is installed on the main unit 11 and the display 12, but the wireless device of FIG. 16 may be installed in the input unit 13 so that the input unit 13 and the main unit 11 may communicate to each other through the wireless device of FIG. 16.

Subsequently, an example of installing the wireless device of FIG. 16 in the mobile terminal 14 will be described with reference to FIG. 17.

The mobile terminal 14 shown in FIG. 17 is a terminal, for example, for performing data processing such as music reproduction. The wireless device of FIG. 16 is provided inside or outside of the mobile terminal 14 and the mutual communication is performed therebetween, for example, using a millimeter-wave band frequency.

For example, the mobile terminal 14 performs data communication (e.g., music downloading) to and from the main unit 11 shown in FIG. 17 through the wireless device of FIG. 16. Alternatively, the mobile terminal 14 may perform data communication directly to the display 12 to display an image stored in the mobile terminal 14 on the display 12. Further, the mobile terminal 14 may perform data communication to and from another mobile terminal (not shown) having the wireless device of FIG. 16 through the wireless device of FIG. 16 to exchange music or images.

As described above, according to the present embodiment, data and images can be preferably sent and received by installing the modularized wireless device of FIG. 16 in a wireless communication device such as a device for sending and receiving data or images and the mobile terminal 14.

In addition, since the wireless device of FIG. 16 is modularized, the wireless communication device can be easily installed in these wireless communication devices. Further, since the wireless device of FIG. 16 is as extremely small as a semiconductor chip, the wireless communication device can be provided in a small space such as a side wall of the display 12 and the mobile terminal 14, thereby increasing the design flexibility.

### Tenth Embodiment

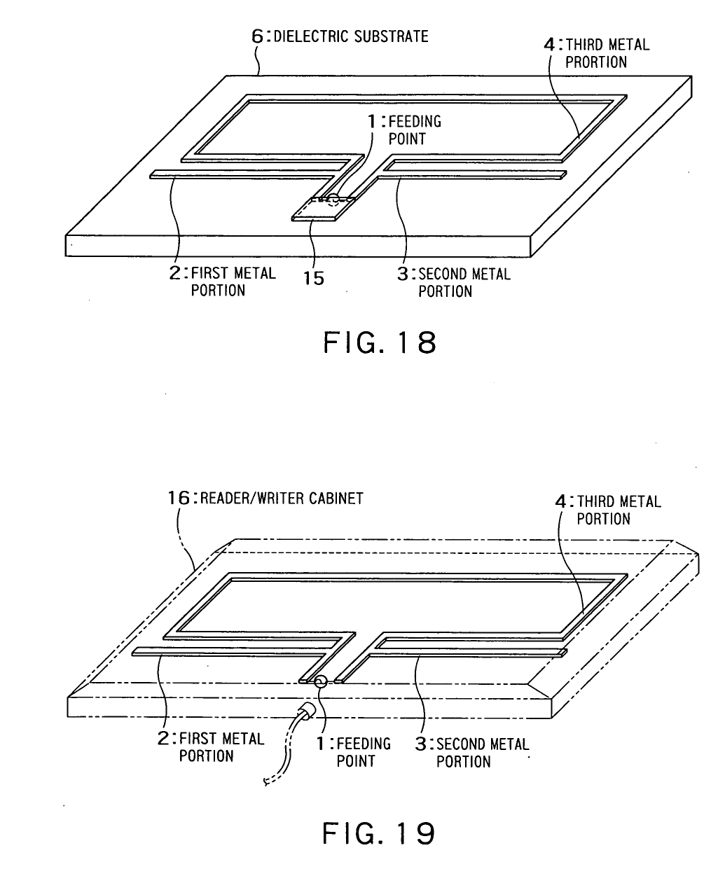

FIG. 18 shows a schematic configuration of a wireless device in accordance with a tenth embodiment of the present invention.

The wireless device is an IC tag for use in an RFID system and is provided with the wireless communication device of FIG. 8; an IC chip (wireless chip) 15 connected to the feeding point 1 of the antenna device; and the dielectric substrate 6.

Here, the example shows that the antenna device of FIG. 8 is provided on the IC tag, but the antenna device of FIG. 1 or 11 may be provided on the IC tag.

As described above, the antenna device in accordance with the present invention provided in an IC tag for use in an RFID system can provide a preferable communication with little degradation of radiation efficiency and with little variation of impedance in any communication whether the IC tag is attached to a metal or lossy material or the IC tag is provided in a free space.

### Eleventh Embodiment

FIG. 19 is a schematic configuration of a wireless device in accordance with an eleventh embodiment of the present invention.

The wireless device is configured such that the antenna device of FIG. 8 is provided in a reader/writer device for use in an RFID system. The antenna device is provided in a cabinet 16 of the reader/writer device. Here, the example shows that the antenna device of FIG. 8 is provided in the reader/writer device, but the antenna device of FIG. 1 or 11 may be provided in the reader/writer device.

As described above, the antenna device in accordance with the present invention provided in the reader/writer device can provide a preferable communication with little degradation of radiation efficiency and with little variation of impedance even if the reader/writer device must be close to a metal or lossy material at the time of reading or writing.

### Twelfth Embodiment

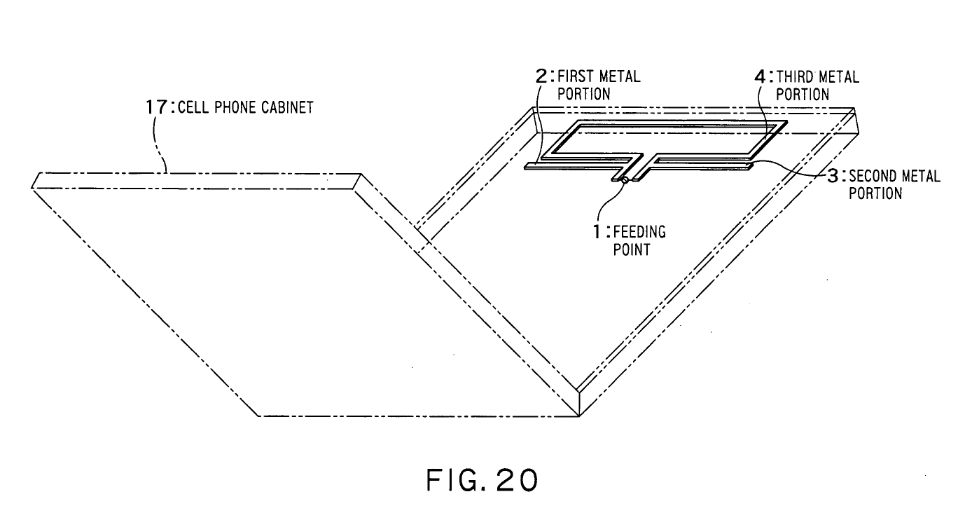

FIG. 20 shows a schematic configuration of a wireless communication device in accordance with a twelfth embodiment of the present invention.

The wireless communication device is configured such that the antenna device of FIG. 8 is provided in a cell phone. The antenna device is provided inside a cabinet 17 of the cell phone. Here, the example shows that the antenna device of FIG. 8 is provided in the cell phone, but the antenna device of FIG. 1 or 11 may be provided in the cell phone.

As described above, the antenna device in accordance with the present invention provided in the cell phone can provide a preferable communication with little degradation of radiation efficiency and with little variation of impedance even if a metal or lossy material such as a human body is close to the cell phone.

The present invention is not limited to the exact embodiments described above and can be embodied with its components modified in an implementation phase without departing from the scope of the invention. Also, arbitrary combinations of the components disclosed in the above-described embodiments can form various inventions. For example, some of the all components shown in the embodiments may be omitted. Furthermore, components from different embodiments may be combined as appropriate.

What is claimed is:

1. An antenna device comprising:
a dipole element that includes a first linear element and a second linear element with each one end thereof being provided closely, the dipole element having a length of approximately one-half of a wavelength of an operating frequency;
a loop-shaped element that includes a third linear element and a fourth linear element provided approximately in parallel to the first linear element and the second linear element with each one end thereof being provided closely, and a fifth linear element with one end thereof being connected to the other end of the third linear element and the other end thereof being connected to the other end of the fourth linear element, the loop-shaped element having a length of approximately one wavelength of an operating frequency; and
a feeding point feeding power to each one ends of the first linear element and the second linear element and to each one ends of the third linear element and the fourth linear element.

2. The device according to claim 1, wherein a distance between the first linear element and the third linear element and a distance between the second linear element and the fourth linear element are an approximately one-tenth or less of a wavelength of the operating frequency, respectively.

3. The device according to claim 1, wherein both end portion of the loop-shaped element are folded outward of a loop;
each of the one ends of the first linear element and the second linear element is connected to a middle of each of the folded portions;
the dipole element includes, in addition to the first linear element and the second linear element, a part of each of the folded portions from connection points with the first and the second linear elements to the one ends of the third and the fourth linear elements; and
the feeding point feeds power to the dipole element via the one ends of the third linear element and the fourth linear element.

4. The device according to claim 3, wherein the dipole element is provided on a plane having a height different from that of the loop-shaped element.

5. The device according to claim 1, further comprising a dielectric substrate, wherein the loop-shaped element and the dipole element are formed on a surface of the dielectric substrate.

6. The device according to claim 1, further comprising a dielectric substrate, wherein the loop-shaped element and the dipole element are embedded inside the dielectric substrate.

7. The device according to claim 1, further comprising a conductor ground plane, wherein the loop-shaped element and the dipole element are provided above the conductor ground plane, respectively.

8. A wireless device comprising:
an antenna device as claimed in claim 1; and
a wireless chip configured to perform wireless communication through the antenna device.
